(19) United States
(12) Patent Application Publication
(10) Pub. No.: US 2003/0065730 A1
(43) Pub. Date: Apr. 3, 2003

(54) Method for determining a primary communication module

(76) Inventors: Kevin M. Jones, Tomball, TX (US); Andrew C. Cartes, Cypress, TX (US)

Correspondence Address: CONLEY ROSE, P.C., P. O. BOX 3267, HOUSTON, TX, 77253-3267, US

(21) Appl. No.: 09/966,301

(22) Filed: Sep. 28, 2001

(51) Int. Cl. G06F 15/16

(52) U.S. Cl. 709/208

(57) ABSTRACT

The invention is directed to a system and related method for determining a primary or master communication module in a system where multiple communication modules are present, and where each of the multiple communication modules are capable of operating in the primary or master capacity. Upon power-up, each communication module requests a response from a primary communication module. If no response is received within a predetermined time, the communication module self-promotes to master status, and broadcasts a message of that master status. If a response from a master is received, then the communication module remains in secondary or slave state. If multiple communication modules power on simultaneously, the first to win arbitration on the communication bus that couples them effectively wins the arbitration since that module starts its timer first. If the communication bus is such that multiple messages may transfer simultaneously, then ties regarding master capacity are settled based on highest assigned device address.

### CROSS-REFERENCE TO RELATED APPLICATIONS

This application is related to co-pending application Ser. No. ______ (Att'y. Docket No. 1662-39300) entitled “Intelligent Power Management for a Rack of Servers.” This application is also related to co-pending application Ser. No. ______ (Att'y. Docket No. 1662-39400) entitled “Broadcast Compressed Firmware Flashing.”

### STATEMENT REGARDING FEDERALLY SPONSORED RESEARCH OR DEVELOPMENT

Not applicable.

### BACKGROUND OF THE INVENTION

1. Field of the Invention

The present invention relates generally to rack mounted server or computer systems. More particularly, the preferred embodiments of the present invention relate to power control in rack mounted server systems where the power supplies are centralized. More particularly still, the preferred embodiments of the present invention relate a communication systems and protocols for power control in a rack mounted server system.

2. Background of the Invention

In rack mounted server systems constructed before this invention, each server mounted horizontally in the rack. Thus, observing the front of a previous rack mounted server system, there are a plurality of servers extending from near the bottom of the rack to near the top of the rack, each mounted horizontally.

The standard unit of measure for indicating the density of rack mounted server systems is a unit “U” equal to 1.75 inches. Thus, if a computer or server has a 4U density, that server has a thickness of 7 inches. As of the writing of this specification, commercial rack mounted server systems have servers therein with a 1U thickness, where those servers are mounted horizontally in the rack.

Each computer or server of previous rack mounted server systems is a stand-alone computer that includes one or more processors, RAM, fixed disks, AC to DC power supplies, and the like. In fact, these servers may have as many as three power supplies within each server such that redundancy is accomplished by having the server operational on only two of those three power supplies. AC to DC power supplies however occupy significant space.

In order to decrease server footprint, and thus increase the number of servers that may be placed within a rack, it has been proposed to remove the individual AC to DC power supplies from the servers and place those power supplies at a central location, e.g., near the bottom of the rack. By removing the power supplies from the individual servers within the rack, it is possible to decrease the size of the servers to less than 1U. While removing power supplies and centralizing those supplies within the rack mounted server system may aid in decreasing the footprint of each individual server, this separation of the power supplies from the servers creates problems with regard to how to manage the shared power supply resource, as well as how to allocate and de-allocate power during normal and emergency operating conditions.

A solution to these problems is presented in the co-pending application titled “Intelligent Power Management for a Rack of Servers,” (Ser. No. ______ (Att'y. Docket No. 1662-39300)). In broad terms, the solution presented in the co-pending application is a dedicated communication infrastructure for passing various requests for allocation of power to the central power supplies, and likewise responses to those requests. The preferred arrangement described in the related application is a plurality of communication modules, some associated one each with a chassis of servers in the rack, and others associated one each with power supply assemblies in the rack, all of which preferably communicate on behalf of the of their servers and individual power supplies, respectively. The co-pending application titled “Broadcast Compressed Firmware Flashing,” (Ser. No. ______ (Att'y. Docket No. 1662-39400)) addresses issues related to updating software in those various communication modules. In such a system, especially where multiple communication modules are present, there is a need for making a determination as to which of the various communication modules is the primary or master communication module.

Thus, what is needed in the art is a way to determine a primary or master devices in systems where multiple such independent devices have the ability to take on the primary or master role.

### BRIEF SUMMARY OF THE INVENTION

The problems noted above are solved in large part by a system and related method where each power supply communication module has the ability to be the primary power supply communication module, and each has a mechanism for making a determination as to which power supply communication module has that responsibility. The determination is preferably made by having each power supply communication module power up in a secondary or slave mode. Once powered up, each module sends a broadcast message requesting a response from the primary power supply communication module in the system. If no primary power supply communication module exists in the system, no response is received. If no response is received the power supply communication module self-promotes to primary. Inasmuch as each power supply communication module has this ability, in the preferred embodiment the arbitration for the primary power supply communication module status is effectively won or lost in the arbitration to make the initial communication on the RS-485 bus.

### BRIEF DESCRIPTION OF THE DRAWINGS

For a detailed description of the preferred embodiments of the invention, reference will now be made to the accompanying drawings in which:

FIG. 1 shows a perspective view of a rack for a rack mounted server system;

FIG. 2 shows a perspective view of a chassis of the preferred embodiment;

FIG. 3 shows a front elevational view of a rack mounted server system having two chassis and two power supply assemblies;

FIG. 4 shows an electrical block diagram of power distribution in the server system of the preferred embodiment;

FIG. 5 shows an electrical block diagram of a power management system for the server system of the preferred embodiment;

FIG. 6 shows an electrical block diagram of a server 30;

FIG. 7 shows an electrical block diagram of a chassis communication module of the preferred embodiment;

FIG. 8 shows an electrical block diagram of an individual power supply; and

FIG. 9 shows a flow diagram for determining the primary power supply communication module of the preferred embodiment.

### Notation and Nomenclature

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

Certain terms are used throughout the following description and claims to refer to particular system components. As one skilled in the art will appreciate, computer companies may refer to a component by different names. This document does not intend to distinguish between components that differ in name but not function. The following non-limiting definitions are provided to aid in understanding the preferred embodiments of this invention:

Rack—a rack is a structural system that forms a frame for mounting other devices therein in a rack mounted computer system. The rack could be as simple as a top, a bottom and four corner pieces forming the structure, but may also include decorative or functional coverings around and on those structural components.

Chassis—a chassis is a structure, typically smaller than the overall rack, that is mounted within the rack. In the preferred embodiments of the present invention, individual servers are mounted in the rack mounted system by insertion into the chassis structures. A chassis may alternatively be referred to as a port or an enclosure.

Server—a server is an individual computer mounted within a rack system. Because most computers mounted in rack systems perform server-type operations, throughout this discussion those devices will be referred to as servers. However, the description herein pertains equally to any computer system performing server operations or otherwise.

### DETAILED DESCRIPTION OF THE PREFERRED EMBODIMENTS

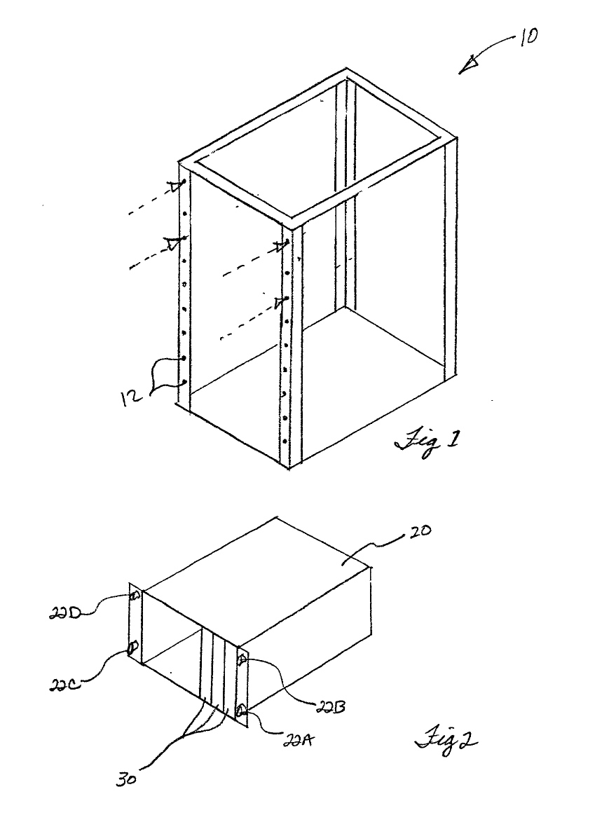

FIG. 1 shows a rack 10 for a rack mounted server system. The rack 10 preferably comprises a plurality of structural members which form the frame of the rack mounted system. On a front portion of the rack 10 are a plurality of threaded holes 12 which are adapted to hold various devices within the rack 10.

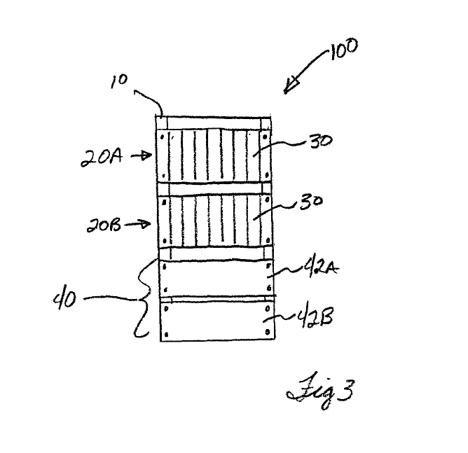

FIG. 2 shows a chassis 20 of the preferred embodiment. The chassis 20 is preferably adapted to slide into the rack 10 and mount at any particular location by use of the knurled knobs 22A-D. These knurled knobs preferably have a threaded portion (not shown) which couple to the threaded holes 12 of the rack 10. These knurled knobs 22A-D, and many other devices familiar to one having ordinary skill in the art, hold the chassis 20 within the rack 10. Each chassis 20 of the preferred embodiment is constructed such that a plurality of servers may be installed therein. Referring still to FIG. 2, the chassis 20 is preferably adapted to hold the servers 30 in a vertical position. While only three such servers are shown in FIG. 2, in the preferred embodiment each chassis 20 is adapted to hold eight servers 30. Further, each chassis 20 is also adapted to hold various communication modules which allow the servers 30 within the chassis 20 to communicate with each other and to external systems and devices.

FIG. 3 shows a front view of a rack mounted server system 100 of the preferred embodiment. In particular, FIG. 3 shows two chassis 20A and 20B mounted within the rack 10. Each chassis preferably houses a plurality of servers 30. While any number of chassis 20 may be used in a server system 100, the preferred embodiment envisions having at least one, and no more than six chassis 20 in any one system.

As mentioned in the Background section, in order to place the preferred eight servers 30 within each chassis 20, preferably none of these servers 30 contain on-board AC to DC power supplies (but preferably do have DC to DC power supplies, which take up significantly less space). Rather, and still referring to FIG. 3, power is supplied for each server 30 in the server system 100 from a power supply system 40. In the preferred embodiment, the power supply system 40 comprises two power supply assemblies 42A, B. The number of power supply assemblies 42 required for any particular server system 100 will be dependent upon the number of chassis 20 and the number of servers 30 within those chassis. For a server system 100 having six such chassis with each chassis preferably housing eight servers 30, preferably two power supply assemblies 42A, B are required. If more chassis are added, more power supply assemblies 42 may be required. Likewise, if fewer chassis are used, and therefore fewer servers 30 are used, it is possible that the power supply system 40 may include only a single power supply assembly 42.

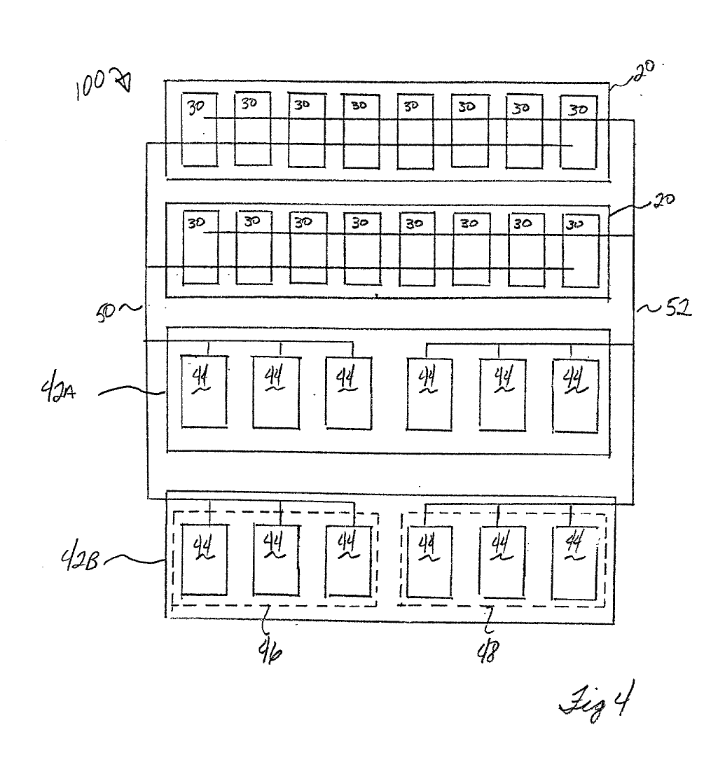

FIG. 4 shows an electrical schematic for power distribution in a server system 100 of the preferred embodiment. Preferably, each power supply assembly 42 comprises a plurality of individual power supplies 44, and in the preferred embodiment, each power supply assembly 42 has six such individual power supplies 44. Preferably, the individual power supplies 44 within a power supply assembly 42 are divided into two banks 46 and 48 (the banks 46 and 48 are shown only on power supply assembly 42B, but are equally applicable to all power supply assemblies). The individual power supplies 44 in each bank 46, 48 then place their power on respective power supply rails 50 and 52.

In the rack mounted server system 100 of the preferred embodiment, the power supply rails 50, 52 are fully redundant supplies to the servers 30 in the chassis 20. In other words, the bank 46 of the power supply assemblies 42 that feed a particular rail are preferably capable of supplying all the necessary power to operate the server system 100. Likewise, the second bank 48 of the power supply assemblies 42 are also preferably adapted to supply all the necessary power to operate the server system 100. In this way, the power supplies may be operated in a fully redundant fashion. FIG. 4 indicates this ability by showing that each server 30 is coupled to each power rail 50, 52. Thus, in the preferred embodiments, each set of servers 30 in each chassis 20 are preferably adapted to have the capability to take their full required operational power from either rail, thus implementing the full power supply redundancy of the preferred embodiment. FIG. 4 however does not indicate any ability for the servers to communicate with the power supply system 40. Although it may be possible to operate a server system that has little or no communication between the power supply system in the servers themselves, the preferred embodiments of the present invention implements an intelligent allocation and de-allocation of power. This intelligent allocation and de-allocation requires some form of communication between the power supply system and the computers or servers.

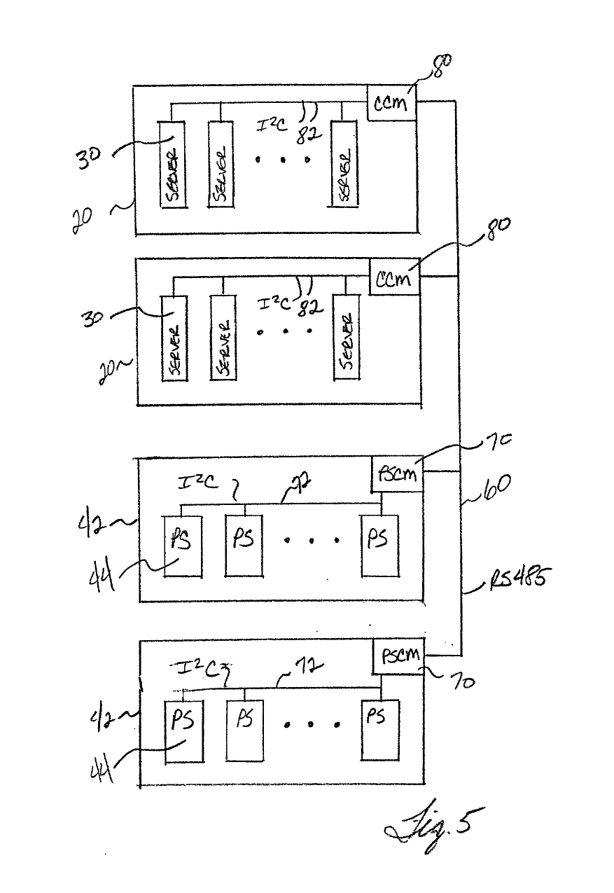

FIG. 5 shows the preferred implementation of a power management system for a rack mounted server system, which allows various components associated with the servers 30 to communicate with the power supply assemblies 42. In particular, the preferred embodiment implements a serial communication pathway 60 coupling each of the power supply assemblies 42 and each chassis 20. This serial communication pathway 60 preferably comprises an Institute of Electrical and Electronic Engineers (IEEE) RS-485 compliant system. However, while the RS-485 system is preferred, communication between the power supply assemblies 42 and the servers 30 within the chassis 20 may take place by any suitable serial or parallel common communication bus and protocol. Although it may be possible to have each server 30 and each power supply 44 in the server system 100 communicate over the serial communication pathway 60, this is impractical. In the preferred embodiment there may be up to six chassis 20, each housing eight servers 30. Thus, there may be as many as forty-eight individual servers 30 in the system. Further, the preferred embodiment may comprise as many as two power supply assemblies 42, each having as many as six individual power supplies 44 for a total of twelve individual power supplies 44. In such a system, allowing each individual device to communicate on the serial communication pathway 60, as many as sixty individual devices would be vying for and arbitrating for the ability to communicate thereon. Additional problems would ensue in such a system in designating a particular primary or other device to make decisions regarding allocation and de-allocation of power.

Rather than allowing each individual server 30 and power supply 44 to communicate on the serial communication pathway 60, the preferred embodiment implements a plurality of communication modules. In particular, and still referring to FIG. 5, each of the power system assemblies 42, and each of the chassis 20, preferably have a communication module that is responsible for relaying messages to the serial communication pathway 60, and making decisions regarding the allocation and de-allocation of power. More particularly still, each power system assembly 42 preferably comprises a power supply communication module 70 (PSCM) mounted proximate to its respective power system assembly 42. In the preferred embodiment, each power system communication module 70 is mounted on or near a backplane board of each respective power system assembly 42.

In broad terms, a power supply communication module 70 is responsible for communicating with each individual power supply 44 in its respective power supply assembly 42 to determine parameters of each individual power supply 44 such as fan operability, the internal temperature of the power supply, the power supply input power (incoming AC power), output current, and output amps. The power supply communication module is also responsible for monitoring power supply assembly 42 level parameters such as operability of external fans, temperature of the operating environment, and power loading of the system. Knowing these parameters is important in implementing the intelligent allocation and de-allocation of power for the entire rack mounted server system 100.

In the preferred embodiment, the power supply communication module 70 is also capable of communication across the serial communication pathway 60 to other power supply communication modules and other chassis communication modules 80 (discussed below). Each power supply communication module 70 communicates with the individual power supplies 44 in the particular power system assembly 42 by means of a I²C bus 72. The I²C bus is a dual line, multidrop serial bus developed by Philips Semiconductors that comprises a clock line and one data line. The devices connected to the I²C bus can act as either primary or secondary devices (or alternatively master or slave respectively), and each device is software addressable by a unique address. Primary devices can operate as transmitters, receivers, or combination transmitter/receivers to initiate 8-bit data transfers between devices on the bus. The I²C utilizes arbitration to prevent data corruption when two or more master or primary devices desire simultaneously transfer data. Details regarding the I²C bus may be found in “The I²C-Bus Specification,” Version 2.1 (January 2000), authored by Philips Semiconductors®. Although the I²C bus is the preferred communication pathway between the individual power supplies 44 and the power supply communication module 70, substantially any serial or parallel communication system and protocol would be operable.

Still referring to FIG. 5, much like the power supply assemblies 42, each chassis 20 preferably comprises a chassis communication module 80 (CCM). The chassis communication module 80 preferably communicates with each server 30 within its particular chassis 20, and preferably relays messages as necessary to and from the serial communication pathway 60. The chassis communication module 80 is not only adapted to communicate using the preferred RS-485 on the serial communication pathway 60, but also preferably communicates to each individual server 30 within its chassis 20 by means of an I²C serial communication pathway 82. While the I²C communication pathway 82 is preferred, any suitable communication system and protocol may be used to facilitate the communication.

FIG. 6 shows a partial electrical block diagram of a server 30. The server is preferably a computer system having one or more microprocessors and other devices required for normal computer system operation, but the server 30 preferably does not include a power supply for converting AC power to DC power. However, the server 30 preferably does comprise a DC-DC power supply to convert the preferred −48 volt DC power supplied from the power supply system 40 into the required operational voltages for the microprocessor and other sub-systems. Further, the server 30 also comprises a communication device 32 which is at least in part dedicated to communicating over the I²C bus 82 with the chassis communication module 80. As discussed more fully below, this communication device 32 preferably becomes operational just after the server 30 is placed within the chassis 20. That is, the communication device 32 is preferably powered and active before the remaining portions of the server 30 are allowed to power up. The communication device 32 functions may be implemented in any of an array of possible devices familiar to one of ordinary skill in the art. In the preferred embodiments of the present invention, however, the functions of the communication device 32 are implemented in an Application Specific Integrated Circuit (ASIC) along with other functions that are beyond the scope of this specification. The communication device 32 functions could, likewise, be implemented in a microcontroller programmed to perform such a task, or even in combinational logic.

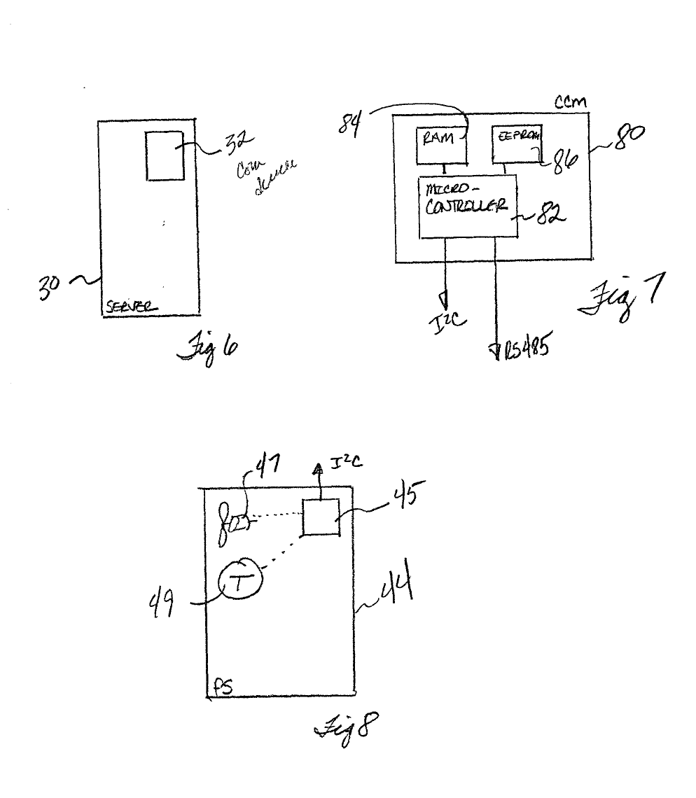

FIG. 7 shows a more detailed electrical block diagram of the chassis communication module 80 of the preferred embodiment. In particular, the chassis communication module 80 comprises a microcontroller 82, which is preferably a part No. ZIRCON-LH2 manufactured by Qlogic Corporation. This microcontroller 82 preferably has external RAM 84, which is the working area for the microcontroller 82. The microcontroller 82 also is preferably coupled to an external EEPROM 86 for semi-permanently storing programs and other data for use by the microcontroller. Preferably each of the chassis communication modules 80 are substantially the same, save their associations with different chassis 20. Although there is not a specific figure detailing the electrical components of each power supply communication module 70, it is envisioned that the hardware on each of these modules 70 will be substantially the same as a chassis communication module 80. Software executed by a microcontroller implementing the chassis communication module or the power supply communication module may differ given their duties in communicating with different devices. Further, in the preferred embodiments, the power supply communication modules 70 does not require a DC-DC power supply, as auxiliary 5 volt power is preferably available from the individual power supplies 44. The chassis communication modules 80, however, preferably have a DC-DC power supply capable of converting the preferred −48 volt DC supply into operable voltages for the on-board microcontroller and related circuitry.

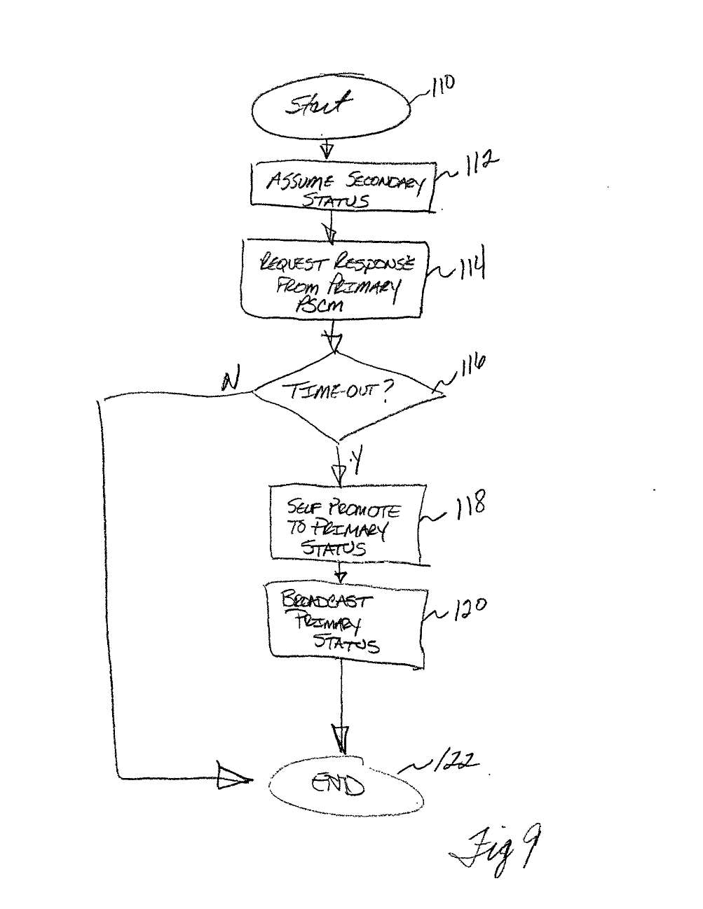

FIG. 8 shows a partial electrical block diagram of an individual power supply 44. Note that the figure only shows components related to the preferred embodiments—standard power supply components are omitted for the sake of clarity. Each power supply 44 preferably comprises a health and status monitoring device 45. As the name implies, the health and status monitoring device 45 is responsible for monitoring various parameters of the individual power supply 44 to which it is associated. In particular, the health and status monitoring device 45 preferably monitors any internal fans 47 of the power supply, the internal temperature 49 of the power supply 44, input power, output current, and output voltage. The health and status monitoring device 45 preferably communicates the gathered information to the power supply communication module 70 by way of the I²C bus. The health and status monitoring device 45 may be as simple as combinational logic designed and constructed to implement the functions, but preferably is a microcontroller programmed to monitor the various parameters of the power supply 44 by way of input signals, and also programmed to communicate with the power supply communication module 70 over the I²C bus 72. If using combinational logic, the health and status monitoring device 45 may also require an interface circuit (not shown) to interface to the I²C bus 72. This interface could be a part no. PCF8575 I²C I/O expander manufactured by Phillips Semiconductor.

Having now described the underlying hardware associated with the intelligent power management for the rack of servers, attention is now turned to the preferred methods of allocating and de-allocating power in the rack mounted server system 100. For purposes of explanation, consider a rack mounted server system having a power supply system 40 with two power supply assemblies 42. Further, assume that each of the power supply assemblies 42 has the preferred six power supplies 44, in two banks 46, 48. Further assume that there are six chassis 20 within the rack mounted server system 100, but assume that no servers 30 have been installed therein. Thus, the individual power supplies 44 of the power supply assemblies 42 may communicate with their power supply communication module 70, and each power supply communication module 70 may communicate with the chassis communication modules 80, but no servers 30 have been installed.

Now assume that a single server 30 is inserted in a chassis 20. Upon insertion, the communication device 32 (see FIG. 6) of the server draws power from either or both of the power rails 50, 52. It must be understood, however, that the power drawn by the communication device 32 of the server is very small in comparison to the amount of power required to operate the server 30. It must further be understood that in the preferred embodiments the servers do not automatically begin their power-up sequence upon insertion into the chassis 20. Rather, the communication device 32, after itself being powered and operational, communicates to its respective chassis communication module 80, requesting permission to draw or allocate power from the power rails 50, 52. In the preferred embodiment, the communication device 32 within the server is aware of the total power a server requires. This knowledge on the part of the communication device may take many forms, but preferably the information is written to an EEPROM (not show) within the server 30. The communication device 32 refers to the number stored in the EEPROM, and includes that power amount in the request to the chassis communication module 80. The chassis communication module 80 relays the request to the primary of the two power supply communication modules 70 (determining which of the power supply communication modules 70 is the primary is discussed more filly below). The primary power supply communication module probes its power supplies 44 to make a determination as to available capacity. In the system assumed for purposes of discussion, the primary power supply communication module also asks the secondary power supply communication module to make a similar determination with respect to power capacity in its respective power supply assembly 42. If the primary power supply communication module determines that there is enough available capacity to supply the request, then a permission granted message is relayed back to the requesting chassis communication module 80, which in turn grants permission for the requesting server 30 to draw power and begin the boot process. Although the preferred embodiment for allocating power is described in the context of the plugging a first server 30 into a chassis 20, the operation is substantially the same for any power on operation. Consider a server 30 already installed in the chassis 20, but powered down. Any of a host of actions may precipitate powering of the server 30, e.g., pressing of a front panel power button, LAN based requests to power on, and/or activity that requires the server 30 to power on from a sleep state. Preferably the communication device 32 monitors these and any other parameter that may precipitate powering of the server 30, and prior to allowing the server 30 to allocate power, the communication devices requests permission to allocate power as described above.

For purposes of discussing release of power during normal operations, consider a chassis 20 substantially populated with servers 30, all drawing power from the power supply system 40. For any of a myriad of reasons, a server may be powered down. These reasons may include, but are not limited to, pressing of a power button on the server 30, performing a software shutdown, or abruptly removing the server 30. In the cases where an orderly shutdown is perform, e.g., pressing the power button and performing software shutdowns, the server 30, in particular the communication device 32, preferably communicates with its respective chassis communication module 80 that the power has been released. A similar situation arises where there server 30 reduces power consumption, such as by entering a low power mode or sleep state. Thus, the release of power is then preferably communicated to the primary power supply communication module 70. If other servers 30 had previously been denied permission to power on for lack of available power, those servers 30 may now be granted permission. In the case where the server 30 is abruptly removed, the preferred communications may not take place; however, each chassis communication module 80 preferably monitors the presence of each server 30, and informs the primary power supply communication module 70 of the effective release of power.

Now assume either of the following: 1) that the chassis is substantially populated with servers 30, each server operating and drawing substantial amounts of power, the demand approaching the total capacity of the power supply system 40; or 2) malfunctions of individual power supplies 44 within each power supply assembly 42 have limited the capacity of the overall power supply system 40. Now assume that another server 30 is inserted into a chassis 20 of the rack mounted server system 100. As described before, the communication device 32 of the server 30 powers up (again a minimal amount of power) and requests permission to power up the individual server. The request to draw power from one of the power rails 50, 52 is relayed as discussed above to the primary power supply communication module which makes the determination, as before, as to available power. However, in the assumption of this case, there is not enough available capacity in the power supply system 40 to supply the requesting server 30. In this circumstance, the preferred embodiment relays a denial of the request back to the requesting server 30 by way of its respective chassis communication module 80, and thus the server preferably does not power on.

It must be understood that while certain assumptions were made as part of the explanation of the intelligent power allocation, many circumstances may arise when a server 30 is not allowed to draw power from the power rails 50, 52. Further, the discussion above indicates that the decision to grant or deny a particular server to draw power from the power rails was based on a desired operating condition, such as capacity. However, this may not be overall capacity, but preferably is a determination based upon retaining necessary power for full redundancy. That is, while the power supply system 40 may have had the necessary capacity to supply the particular requesting server, the primary power supply communication module 70 may be programmed to not allow allocation of power beyond that which would jeopardize the power supply system's 40 ability to fully supply necessary power to the rack mounted server system 100 from either of the power rails 50, 52. Allocating power to maintain full redundancy is the preferred implementation, but it is certainly not required. If so desired, the system may operate in a state where full redundancy is not maintained.

For purposes of discussing intelligent de-allocation of power in a server system 100 of the preferred embodiment, consider a system having a plurality of chassis 20, each chassis having a plurality of server systems 30, and the system also having a power supply system 40 operating on the brink of its capacity (whether that is total capacity or capacity with regard to insuring full redundancy). Further, assume that an operational problem develops in one of the individual power supplies 44 of the power supply system 40. While the loss of an individual power supply may not result in the loss of any of the servers 30 in the system because of redundancy, the power redundancy in the situation may be lost. In the preferred embodiment, the primary power supply communication module 70 is informed of the loss (either by direct communication across its respective I²C bus from a power supply 44, or if the failure was in the power supply assembly associated with the secondary power supply communication module 70, by communication from the secondary power supply communication). Once the primary power supply communication module determines the desired operational limits have been exceeded, the power supply communication module preferably requests that individual servers 30 power down to reduce power load. This requesting and powering down of servers 30 preferably continues until the desired operating condition has been restored. Through substantially the same process, servers may again allocate power and become operational once power capacity is restored.

Although each server 30 within a rack mounted server system 100 is substantially identical at the hardware level to the other servers 30 in the system, some servers may be more critical to the particular operation. Consider an electronic commerce (e-commerce) site. In such a system, it may be that only a small number of the individual servers 30 are absolutely critical—servers containing the e-commerce database. The remaining servers 30 in the rack mounted server system 100 may be only responsible for servicing internet traffic. In this assumed circumstance, the few servers 30 that contain the actual e-commerce database are significantly more important to maintain an operational status than servers handling web traffic. In the preferred embodiment, the server system 100 is capable of intelligently de-allocating power, for example in emergency situations, from non-critical servers 44 before the critical servers are requested to shut down. In particular, in the preferred embodiment each server 30 in the rack mounted server system 100 is assigned a priority number. Thus, if there are six individual chassis 20 within the rack mounted server system 100, each chassis having eight servers 30 mounted therein, then 48 total levels of priority will be distributed among the 48 servers. In the event of a malfunction or failure of the power supply system 40, the primary power supply communication module 70 requests a power or shut down of the lowest priority server. After this server is shut down and its power requirements returned to the pool, the primary power supply communication module 70 again analyzes the power requirements and may again request the next priority level server to be shut down. This procedure continues until enough servers 30 have been shut down to restore the rack mounted computer system into its desired state of operation. It must be remembered that the shutting down of servers may be to ensure that there is enough power to operate them at all, or it may be to ensure that full redundancy of the power supplies is maintained. It must be understood, however, that while the method described above is the preferred way to implement the intelligent power de-allocation, there are many equivalent ways of performing this task. For example, each chassis communication module may be programmed to know the relative importance of each server 30 within its respective chassis 20. Equivalently, the power supply communication module may be programmed with this information and thus may request particular servers to be shut down. One of ordinary skill in the art, now understanding the objectives of the intelligent power de-allocation, could devise many structures and methods to perform this task.

As discussed above, in the preferred embodiment, only one of the power supply communication modules 70 is designated as primary or master, and the second is designated as a secondary or slave. While it may be possible to hardwire or hardcode this primary and secondary relationship, in the preferred embodiment each of the power supply communication modules 70 is capable of taking on the primary responsibility. Thus, if one power supply communication module 70 is lost due to hardware or communication problems, the second power supply communication module 70 may take over that primary responsibility. However, having the plurality of power supply communication modules 70 in the system each having the capability to be the primary requires some method to select a primary as between competing modules. Consider, for purposes of explanation, the initial power-up of a rack mounted server system 100. Upon the initial application of power from the power supply system 40, each power supply communication module 70 becomes operational. FIG. 9 shows a preferred start-up sequence of each of the power supply communication modules 70 with respect to determining the primary power supply communication module 70 of the particular rack mounted computer system 100. In particular, each power supply communication module preferably starts this process as indicated in block 110 and then immediately assumes a secondary status as indicated by block 12. After assuming a secondary status, the communication module 70 requests a response from the primary power supply communication module as indicated in block 114. In the condition where a power supply communication module has been replaced or is otherwise restarted separate and apart from other power supply communication modules, a primary will already be assigned and thus a response could be expected. However, in the situation where each power supply communication module 70 is starting its sequence substantially simultaneously, there may not be a primary to respond to the request indicated in block 114. Thus, preferably a timer is started, and the path taken is dependant upon whether a response from a primary power supply communication is received before the timer runs out as indicated in block 116. If no response is received before a time out of the timer, the power supply communication module 70 preferably self-promotes to the primary status as indicated in block 118. After self-promoting to primary, the power supply communication module broadcasts its primary status as indicated in block 120. This broadcast is preferably not only to other power supply communication modules, but also to chassis communication modules 80 in the system. In this way, each communication module in the system is aware of which power supply communication module is primary. All communications from the chassis communication modules 80 are thereafter directed to the primary power supply communication module (unless that primary status changes for some reason).

In the situation however where there is already a primary power supply communication module 70, the length of the timer is preferably set longer than the amount of time it may take that primary to respond. Thus, if a response is received before a time out of the timer as indicated in block 116, the particular power supply communication module remains in its secondary status. The flow diagram indicates this feature by having the process move from block 116 to the end block 122.

Because power supply communication modules 70 of the preferred embodiment communicate with each other across the RS-485 bus, the determination as to which module will be the primary module is effectively determined as of the time one of these modules wins arbitration on the RS-485 bus to request a response from the primary, as indicated in block 114. Thus, in the preferred embodiments, there is no chance that two power supply communication modules will simultaneously self-promote. However, if the serial communication pathway 60 is changed such that multiple simultaneous communication may occur, there may have to be other mechanisms for determining which power supply communication module should be the primary, for example, choosing a primary based upon the highest assigned physical address, or the like.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. In a system having multiple communication modules coupled to a communication pathway, a method of operating a communication module comprising:
powering the communication module;
operating the communication module initially in a secondary status;
broadcasting a request on the communication pathway for a response from a primary communication module;
operating the communication module in a primary status if no response is received from the primary communication module; and
broadcasting a message indicating the primary status.

2. The method of operating a communication module as defined in claim 1 wherein broadcasting a request on the communication pathway for a response from a primary communication module and operating the communication module in a primary status if no response is received from the primary communication module further comprises:
starting a timer after the broadcasting a request step;
monitoring the communication pathway for a response from the primary communication module; and
self promoting to the primary status if no response to the request is received before the timer reaches a predetermined time.

3. The method of operating a communication module as defined in claim 1 further comprising continuing to operate in the secondary status if a response is received from the primary communication module before the timer reaches a predetermined time.

4. A system comprising:
a first communication module;
a second communication module;
a first communication pathway coupling the first communication module and the second communication module; and
wherein each of the first and second communication modules are adapted to initially assume a secondary status, request a response from a primary communication module, self promote to primary status if no response is received, and if applicable, broadcast the primary status across the first communication pathway.

5. The system as defined in claim 4 wherein the first communication module is a power supply communication module in a rack of servers.

6. The system as defined in claim 5 wherein the second communication module is a power supply communication module in a rack of servers.

7. The system as defined in claim 6 wherein the first communication pathway is an RS-485 communication pathway.

8. The system as defined in claim 4 further comprising:
a third communication module coupled to the first and second communication modules through the first communication pathway;
wherein the third communication module monitors the first communication pathway to ascertain which of the first and second communication modules is primary; and
wherein the third communication module directs communications one of the first and second communication modules that has taken the primary status.

9. The system as defined in claim 8 wherein the first communication module is a power supply communication adapted to monitor a power supply assembly of a power supply system in a rack of servers.

10. The system as defined in claim 9 wherein the second communication module is a power supply communication module adapted to monitor a power supply assembly of a power supply system in a rack of servers.

11. The system as defined in claim 10 wherein the first communication pathway is an RS-485 communication pathway.

12. The system as defined in claim 11 wherein the third communication module is a chassis communication module adapted to communicate on behalf of servers within a particular chassis in a rack of servers.

13. In a rack mounted server system having a central power supply, the central power supply having at least two power supply assemblies, each power supply assembly having a communication module coupled to other communication modules and other devices across a communication pathway, a method of determining a primary communication module comprising:
assuming initially a secondary status;
requesting a response from the primary communication module;
promoting to a primary status if no response is received; and if the primary status is taken broadcasting the primary communication module status.

14. The method of determining a primary communication module as defined in claim 13 wherein requesting a response from the primary communication module and promoting to a primary status if no response is received further comprises:
broadcasting a request for a response from the primary communication module;
starting a timer; and
self promoting to the primary status if no response to the request is received before the timer expires.

15. The method of determining a primary communication module as defined in claim 13 further comprising remaining in the secondary status if the response is received from the primary communication module before the timer expires.

16. A communication module comprising:
a random access memory (RAM) device;
a read only memory (ROM) device;
a processor coupled to the RAM and ROM devices;
a first communication pathway coupled to the processors;
a second communication pathway coupled to the processor;
wherein the processor is adapted to execute programs stored on the ROM device; and
wherein the programs stored on the ROM device direct the communication module to default to a secondary status for control of the first communication pathway, and wherein the programs further direct the processor to request a response from a primary communication module across the first communication pathway, self-promote to a primary status if no response is received, and broadcast the primary status across the first communication pathway.

17. The communication module as defined in claim 16 wherein the processor further comprises a microcontroller.

18. The communication module as defined in claim 17 wherein the microcontroller further comprises a Zircon-ZH2 manufactured by Qlogic Corporation.

19. The communication module as defined in claim 16 wherein the first communication pathway is a serial communication pathway.

20. The communication module as defined in claim 19 wherein the serial communication pathway further comprises an RS-485 compliant serial communication pathway.

21. The communication module as defined in claim 16 wherein the ROM devices is an electrically erasable programmable read only memory (EEPROM).

22. The communication module as defined in claim 16 wherein the programs stored on the ROM device executed by the processor further direct the communication module to remain in the secondary status if a response is received from the primary communication module.

23. The communication module as defined in claim 16 wherein the second communication pathway comprises an I²C serial communication pathway.

24. In a system having multiple communication modules coupled to a communication pathway, a method of operating a plurality of communication modules comprising:
powering the communication modules;
operating the communication modules initially each in a secondary status;
broadcasting a request on the communication pathway by each of the communication modules for a response from a primary communication module; if no response is received from a primary communication module; and
arbitrating among the communication modules by:
starting a timer in each communication module upon their respective broadcasts of the request;
self promoting to a primary status by a first of the communication modules to have its time expire; and
broadcasting by the first of the communication modules its primary status; operating all but the first of the communication modules in a secondary status.

25. The method of operating a plurality of communication modules as defined in claim 24 further comprising choosing a primary communication module among communication modules whose timers expire substantially simultaneously based on device addresses for each of the communications modules whose timers expire substantially simultaneously.

26. The method of operating a plurality of communication modules as defined in claim 25 wherein choosing a primary based on device addresses further comprises choosing one of the communication modules whose timers expired simultaneously having the highest device address.
